(19) United States
(12) Patent Application Publication
(10) Pub. No.: US 2002/0158009 A1
(43) Pub. Date: Oct. 31, 2002

(54) Volatile acid transfer in biological-abiotic processes

(76) Inventor: Boris M. Khudenko, Atlanta, GA (US)

Correspondence Address: Boris M. Khudenko, 744 Moores Mill Rd., Atlanta, GA, 30327, US

(21) Appl. No.: 09/845,922

(22) Filed: Apr. 30, 2001

(51) Int. Cl. C02F 3/30

(52) U.S. Cl. 210/605; 210/631

(57) ABSTRACT

A method of a wastewater treatment in a system consisting of at least one acid consuming step and at least one volatile acid generating step and further comprising step of evacuating the volatile acid from that at least one step generating at least one volatile acid and step of transferring at least one volatile acid to that at least one acid consuming step.

### FIELD OF INVENTION

The invention belongs to methods for biological-abiotic treatment of materials, and more specifically to the optimal control of pH and alkalinity-acidity in acid-base, hydrolysis, oxidation-reduction and other pH and alkalinity or acidity dependent process steps.

### BACKGROUND

Biological and biological-abiotic processes are often used for treatment of water, municipal and industrial wastewater, some industrial fluids, for example, in fermentation process steps in food or pharmaceutical industries, solid waste of many origins, various hazardous waste, and polluted sites in the natural or man made environments. Performance of biological and abiotic steps in these processes often depends on oxidation-reduction conditions and acid-base conditions, particularly on pH, alkalinity and acidity in reacting media. For example, the optimal pH range for various aerobic and anaerobic steps of organics degradation is considered to be from 6.5 to 8. Optimal pH for nitrification and denitrification are considered to be respectively from 6 to 7.5 and from 6.5 to 7.5. The range of pH in anaerobic processes is from 4.5 (sometimes even lower) to 7.5. However, methanogenic growth is preferably performed at pH 6.5 to 7.5, while hydrolysis of particulate materials and high molecular weight organics occur faster and to a greater degree in a lower pH range. Oxidations of organic and inorganic materials mediated by ferric ions are favored at acidic conditions while oxidations of ferrous ions to ferric is more efficient in a higher pH range. Phosphorus release in facultative (usually called anaerobic) zones in so-called enhanced biological phosphorus removal systems is believed to occur at elevated content of volatile fatty acids. Elevated alkalinity, but not necessarily high pH, is desirable in most anaerobic processes, as well as in activated sludge processes making use of high purity oxygen. Metals precipitate preferably at elevated pH.

Very often pH, alkalinity and acidity are corrected with the use of purchased reagents. The disadvantages of methods with purchased reagents include complexity of processes and controls, additional capital and operating costs, and an increase in salts content in the treated effluents. Recently, control of alkalinity and pH with recuperable reagents and by stripping carbon dioxide were described in U.S. Pat. Nos. 5,798,043 and 5,919,367. These patents are made a part of the present application by inclusion. These methods dramatically reduce the reagent requirements, as well as costs of purchased reagents and the total treatment cost, and offer other advantages. In many known applications, including those described in the above cited patents, alkalinity and acidity are exchanged between and among process stages by recycling liquid streams. However, dilution of the contents of reactors with recycled liquid streams and transfer of biomass between and among the stages can often be drawbacks of these processes.

The main objective of the present invention is to provide a method where the internal and/or recuperable sources of alkalinity and acidity are transferred between and among the process steps without diluting the contents of reactors, without excessive transferring dissolved and precipitated (solid) constituents of media being treated, and without excessive transferring biomass among and between various process stages. Other objectives of the present invention will become apparent from the ensuing description.

### SUMMARY OF INVENTION

This is a method of a wastewater treatment in a system consisting of at least one acid consuming step and at least one volatile acid generating step and further comprising step of evacuating said volatile acid from said at least one step generating said at least one volatile acid and step of transferring said at least one volatile acid to said at least one acid consuming step. In some applications the acid generating and the acid consuming stage can be one and the same. Typical volatile acids generated and utilized in various biological process steps include carbon dioxide, hydrogen sulfide, volatile fatty acids, and their combinations. Volatile acids utilized in this method can take part in controlling acid-base conditions in the acid utilization steps and in the system overall. Volatile acid transferred into acid consuming step can also be at least partially chemically transformed (treated) in this step. For example, VFA can be biologically and/or chemically oxidized or reduced; hydrogen sulfide can be oxidized. Other acids may be precipitated, for example, carbon dioxide and sulfides may upon pH shift form poorly soluble metal salts. The present method can be used for improving multistage anaerobic and anaerobic-aerobic biological processes, including biological-abiotic processes. Specifically, the potential processes include those involving acid-base controls and pH-dependent oxidation-reduction processes. Examples of these processes are phosphorus and nitrogen removal within biological systems, biological-abiotic desulfurization of wastewater, biological-abiotic degradation of organics with recuperable oxidation-reduction species, pure oxygen activated sludge process. Other uses will become apparent to the skilled in the arts when particular application is designed and the principles of making use of the gaseous acidity generated in one process step and transferred and utilized in the same or another process step are utilized.

The present method provides a step of charging recuperable oxidation-reduction species in said system which can be metallic ions, metal containing species, oxyions, nonbiodegradable and insoluble inorganic constituents with variable oxidation-reduction states, nonbiodegradable and insoluble organic constituents with variable oxidation-reduction states, redox ion exchange materials, and combinations thereof Metallic ions and metal containing species include metals selected from the group consisting ofiron, nickel, cobalt, manganese, vanadium, and combinations thereof The method further provides a step of charging at least one recuperable pH-buffering species in said system which can include calcium, iron, nickel, cobalt, and combinations thereof.

The acid consuming step and the step generating volatile acid can be one and the same process step, or they can be sequential process steps, parallel process steps, process steps with liquid recycle, and combinations thereof At least one of said steps conducted preferably at acidic conditions can be provided on a recycle line. Similarly, at least one of said steps generating volatile acid can be provided on a recycle line. The acid consuming steps can be conducted in a multistage reactor. Similarly, the acid generating steps can be conducted in a multistage reactor. Various by-passes and off-line process steps can also be used. The operation mode of these reactors can be a continuous operation, a batch operation, or a combination thereof.

The step of evacuating volatile acid can include stripping with an oxidizing gas, stripping with an inert gas, stripping with water vapors, stripping with a reducing gas, vacuum-stripping, heat stripping, and combinations thereof The step of transferring volatile acid to the recipient process step can include transfer (dissolution) via gas bubbling, transfer with thin film devices, transfer with the use ofgas-liquid jets, transfer with mechanical dispersion devices, transfer across a membrane, and combinations thereof Various compressors, pumps, vacuum devices,jet pumps, etc. can be used in these steps.

The present method can be used for removal of constituents selected from the group consisting of organics removal, BOD removal, COD removal, TOC removal, nutrients removal, phosphorus removal, nitrogen removal, removal of toxic constituents, removal of heavy metals, removal of toxic organics, removal of recalcitrant organics, removal of halogenated organics, removal of sulfur species, and combinations thereof.

This is also a method of solid waste treatment in a system consisting of at least one acid consuming step and at least one acid generating step and further providing a step of evacuating said volatile acid from said at least one step of generating said at least one volatile acid and step of transferring said at least one volatile acid to said at least one acid consuming step. Herein said solid waste is selected from the group consisting of municipal solid waste, garbage, industrial solid waste, agricultural solid waste, manure, solid waste from animal farms, polluted soils, wastewater sludges, and combinations thereof It is also a method of treatment of gaseous materials in a system consisting of at least one acid consuming step and at least one acid generating step and further providing a step of evacuating said volatile acid from said at least one step of generating said at least one volatile acid and step of transferring said at least one volatile acid to said at least one acid consuming step.

### DRAWINGS

FIG. 1 is a schematic of a treatment plant with multiple process stages utilizing acid pump for improved phosphorus removal.

FIG. 2 is a flowchart of an anaerobic-aerobic treatment of wastewater with a separate stage for anaerobic hydrolysis.

FIG. 3 is a flowchart of a system for anaerobic (or facultative, or anoxic)-aerobic treatment of wastewater making use of recuperable oxidation-reduction species.

### DETAILED DESCRIPTION OF INVENTION

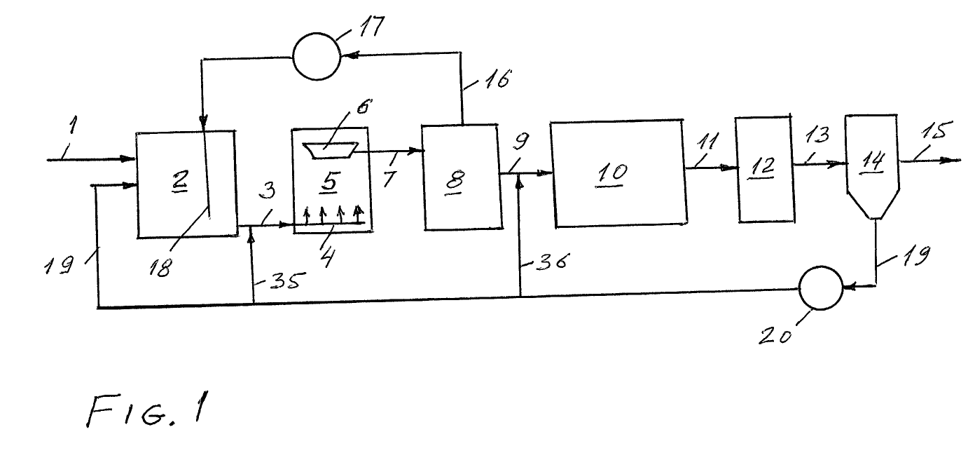

Referring now to FIG. 1, there is shown a biological-abiotic treatment system for phosphorus removal having influent line 1, a facultative (also called anaerobic) step 2 with elevated acidity and/or reduced pH, a line 3 connecting step 2 to an anaerobic process step 5 having a liquid distribution means 4 and, optionally, means 6 for collecting the clarified anaerobic effluent, a line 7 connecting step 5 to a de-acidification step 8 for the removal of the volatile acids from the liquid, a line 9 connecting step 8 to an aerobic step 10, a line 11 connecting said aerobic step 10 to step 12 for the thorough removal of the volatile acids from the treated liquid, a line 13 connecting step 12 to a sludge (biomass) separation step 14, and effluent line 15, a line 19 with a lifting means 20 for recycling at least a portion of the separated biomass to step 2, optionally, biomass can also be recycled to steps 5 and 10 via branches 35 and 36, and a portion of biomass can be wasted (not shown), a line 16 with means for extracting volatile acids 17 and means 18 for the dissolution of volatile acids in step 2.

The method exemplified by FIG. 1 is operated as follows. The influent fed via line 1 and the recycle sludge fed via line 19 both containing phosphorus in either bound form as phosphates, mainly in the sludge, or as organic phosphorus and also dissolved phosphate enter step 1 and are subjected to a biological treatment largely in the absence of oxidizers. Besides metal phosphates, the recycled sludge contains a significant amount of insoluble carbonates, mainly calcium and iron carbonates. Minor quantities of oxygen, nitrates and nitrites, or ferric iron and the like may be present. Herein, “minor” means, for example, a small fraction as compared with COD of the influent. Additionally, volatile acids, such as carbon dioxide, volatile fatty acids (VFA), and possibly hydrogen sulfide are transferred into step 2 from the subsequent process steps. Under these conditions, very effective hydrolysis of organics and the formation of VFA and carbon dioxide occur. Due to the combined (formed and transferred) quantities of VFA and carbon dioxide, pH in the reactor drops and acidity increases thus providing conditions for acidic hydrolysis, including the hydrolysis of the recycled sludge. These conditions are more favorable for the target reactions than those of the prior art methods. The bound phosphorus becomes dissolved, at least a portion of organic phosphorus is also released in the solution as phosphates. The prevalent form of phosphorus is the well soluble dihydrogen phosphate ions. Simultaneously, multivalent ions (calcium, magnesium, iron and others) are mainly converted in ionic forms, including the quantities of these metals previously associated with carbonates due to the conversion of carbonates into bicarbonates and carbon dioxide. Reduction of COD of the mixed liquor in step 2 may be marginal.

Upon leaving step 2 the mixed liquor is treated to remove acidity and rise pH rapidly, but not necessarily to treat the organics in the wastewater completely, so that a substantial residual COD remains. This is achieved by contacting the liquid with microorganisms consuming VFA, for example with methanogens in the step 5, and by stripping carbon dioxide and residual VFA in the step 8. VFA can be removed as described in the U.S. Pat. No. 5,514,277. During rapid removal of VFA and carbon dioxide, pH and alkalinity rise and acidity drops. The dihydrogen phosphates released in the step 2 are converted into hydrogen phosphate and partially phosphate ions. The former form poorly soluble salts and the latter form virtually insoluble salts with divalent ions. At a low carbon dioxide inventory due to stripping, only limited amount of divalent ions are taken up to form insoluble carbonates. Note that magnesium carbonate is fairly soluble and remains more available for phosphates precipitation than calcium and iron. A fraction of divalent ions may still be available for formation of insoluble carbonates later on in the aerobic step 10. Excess carbon dioxide may be vented out, for example via a branch line attached to line 16 (not shown). Alternatively, excess carbon dioxide may be passed downstream in step 10 in a dissolved state. Instead of wasting, the excess of volatile acids in gaseous form may be directed to the aerobic step wherein VFA and other volatile organics will be largely decomposed into carbon dioxide and water, while carbon dioxide will be stripped by aerating system. More advantageously, VFA may be directed to a dedicated denitrification step wherein thus transferred VFA would be used as a reducing agent instead of the purchased methanol.

When the mixed liquor is fed via line 9 in the aerobic treatment step 10, organics are oxidized with the formation of carbon dioxide and water. Depending on pH and alkalinity, a portion of carbon dioxide is stripped. Accordingly, pH of the mixed liquor rises and carbonates are formed. These carbonates will precipitate the balance of divalent ions, if available. Additionally, further increase in pH and alkalinity as compared with the step 8 will facilitate the conversion of hydrogen phosphate into phosphate ions, thus further reducing the solubility of phosphorus.

In step 12, a thorough stripping of carbon dioxide is achieved, for example, by providing a short-duration, high-intensity aeration. This step improves retention of divalent ions in the system due to the formation of insoluble carbonates and hydroxides at elevated pH. This effect would not be possible to achieve in a complete mix aerobic treatment step and very difficult to achieve in a practicable plug flow step. Better retention of divalent ions increases their inventory available for phosphorus removal.

Removal of phosphorus is governed by the thermodynamic equilibria in the system and by kinetics of crystallization. The amount of divalent ions in the influent must be at least stoichiometric to precipitate phosphates. Otherwise, salts of divalent ions need to be added. In biological systems, phosphate and carbonate ions compete for divalent ions to form insoluble products. In this competition pH plays the crucial role. Calcium carbonates start forming at a slightly lower pH (8.3 at temperature of 25° C. in the absence of other ions) than calcium phosphates (pH=8.7). However, with increasing temperature, alkalinity, concentration of calcium, and total dissolved solids the pH of carbonate and phosphate formation shifts to significantly lower values. Accordingly, both carbonates and phosphates can be formed and precipitated in biological systems with divalent ions. The objective of the present invention is to provide conditions which favor precipitation of phosphates. This is achieved by dissolving carbonates and phosphates under acidic conditions and by a rapid removal of acidity including the portion due to carbon dioxide to precipitate preferentially phosphorus and to limit precipitation of carbonates. If acidity produced due to the decomposition of organics in step 2 is not sufficient to dissolve carbonates and phosphates of divalent metals, than the volatile acid recycle is helpful. Acid recycle is simpler and less expensive than the use of purchased acetic acid or production of VFA from primary or secondary sludges. In order to produce a sufficiently high pH in the system after acid stripping steps 5 and 8, the system can be charged with recuperable alkaline species as described in the U.S. Pat. No. 5,798,048. Later on in the aerobic step more carbon dioxide and carbonates will be produced. Thus produced carbonates will scavenge the balance of divalent ions and largely retain them in the system. The previously precipitated phosphates will remain in solid form in the sludge. With pH further increasing in steps 10 and 12 insoluble phosphates will become more and more stable and the dissolved fraction of phosphates will additionally decline.

A portion of the recycled activated sludge may be delivered via line 19 and a branch 35 prior to the acid removal steps 5 and 8. Additionally, a portion of the recycled activated sludge may be delivered via line 19 and a branch 36 prior to the aerobic step 10. The purpose of these sludge branches is to provide seeds of previously precipitated carbonates and phosphares for a more rapid crystallization of phosphates. Additionally, the recycled sludge can be retained in a vessel (not shown) on line 19 for depletion through reduction of oxygen, nitrates and nitrites, and ferric ions, or even for a partial hydrolysis of the sludge. In the latter case, the volatile acids may also be transferred in the vessel to aid the hydrolysis.

It is clear to those skilled in art that process steps 2, 5, 6, 8, 10, 12, and 14 can be carried out in separate tanks, or in a single partitioned tank, or in functional zones in one or several reservoirs, and lines 3, 7, 9, 11, and 13 may be just holes in walls separating the process stages, or no definite physical arrangement may be associated with these lines, for example, when a tank is partitioned into functional zones not separated by a physical wall. Some process steps can be combined in a single volume, for example, consumption of VFA and carbon dioxide stripping can be in a single reservoir. Additionally, step of carbon dioxide stripping may precede the step of VFA consumption, or these steps may be parallel with a flow recirculating between them. Vessels for conducting steps 2, 5, 8, 10, 12, and 14 can be either covered or open to the atmosphere. Those skilled in art can use available provisions for collecting and extracting volatile gases and dissolving them in liquids in open or covered.

Various known means for mixing and conveying liquids, separating solids from mixed liquor, devices for stripping, conveying, and dissolving volatile acids, and other elements for performing the described functions in the system can be used.

The method illustrated in FIG. 1 is very easy to control. This is in contrast to the so-called enhanced biological phosphorus removal, the process notoriously known for its unpredictability. This method can also be adapted for the nitrogen removal, particularly by recycling a portion of aerobically treated mixed liquor from the step 10 to at least one of steps 2, 5, or 8, wherein nitrates and nitrites will be reduced mainly to nitrogen. Treating the recycled sludge with the transferred volatile acids helps to hydrolyze the excess sludge, thus largely eliminating the problem of sludge treatment and disposal.

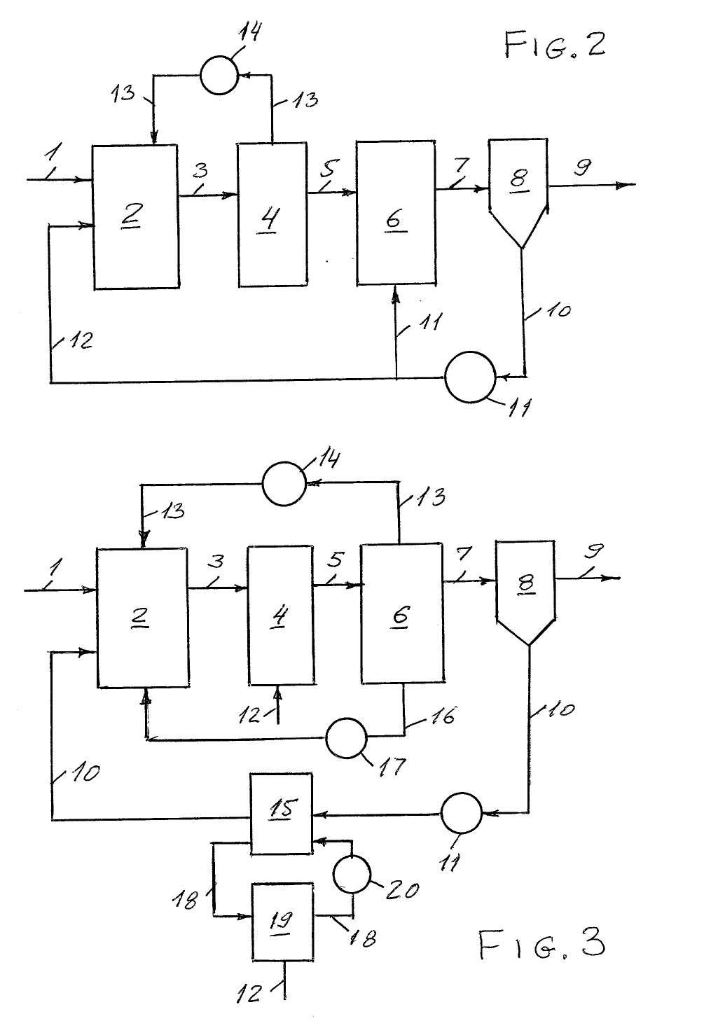

FIG. 2 is a flowchart of an anaerobic-aerobic treatment of wastewater with a separate stage for anaerobic hydrolysis comprising an influent line 1, an anaerobic step 2 for hydrolyzing the solid organic particles, including sludge, and high molecular weight compounds, a line 4 connecting to a rapid aeration step 4, a line 5 connecting to an aerobic step for oxidation of organics, a line 7 going to a final sludge separator 8, and an effluent line 9, a line 10 with a conveying means 11 for recycle activated sludge connects the sludge separator 8 with the aerobic step 6, and a branch 12 for conveying the waste (excess) sludge to the hydrolysis step 2. A gas line 13 with means for stripping volatile acids (not shown) in step 4 and conveying means 14 with means for dissolving the volatile acids (not shown) in step 2 are also provided. Means for stripping may include a spraying means or a film flow device at the top of a reactor accommodating step 4, or other means known to skilled in art. Conveying means 14 may provide a desired vacuum on the suction side and pressure on the discharge side. Means for dissolution of volatile acids may include a simple sparger, or other device also known to skilled in arts.

The method of FIG. 2 is operated as follows. The influent and the excess aerobic sludge are fed in step 2 via lines 1 and 12. A volatile acid gas mainly composed of carbon dioxide and VFA is fed in step 2 from the downstream step 4 via line 13 with the help of the conveying means 14. In step 2, particulate organics, including the aerobic sludge, and high molecular weight compounds are hydrolyzed and further form relatively small molecules of VFA and other organics. Hydrolysis is facilitated by anaerobic microorganisms and the acidic medium provided by the acids generated in step 2 and transferred from step 4. In case of a highly concentrated influent, the step 4 should be preferably operated as a methanogenic step thus reducing the organics content in the liquid in line 5 to low levels acceptable for the economical operation of the aerobic stage 6. In case of weak influent, step 4 may be a step of rapid degassing of the hydrolyzed wastewater without substantial biological action. Aerobic stage 6, sludge separator 8, and sludge recycle 10 are operated as conventional aerobic treatment systems well known to those skilled in arts. The main advantage of the hydrolysis step 2 is in that the excess sludge is mainly eliminated and the sludge treatment and disposal problems and costs are greatly reduced. The method can be easily adapted for treating solid waste, for example, by using leach steps 2 with partial recycle of liquid flow and with the recycle of the volatile acids from the subsequent steps as already described.

FIG. 3 is a flowchart of a system for anaerobic (or facultative, or anoxic)-aerobic treatment of wastewater making use of recuperable oxidation-reduction species comprising an influent line 1, a ferric-ferrous organics oxidation step 2, a line 3 connecting to a rapid oxidation step 4 having oxidizer feed 12 (oxygen, oxygen enriched air, air, or other oxidizer including any suitable liquid or solid oxidizer), a line 5 connecting to another ferric-ferrous organics oxidation step 6, a line 7 leading to a final sludge-liquid separation step 8, an effluent line 9, a sludge recycle line 10 with conveying means 11 ultimately leading to step 2, and an optional rapid oxidation step 15. Also optional, a sludge oxidation step 19 with connecting line 18 and conveying means 20 are provided in parallel to the step 15. An optional mixed liquor recycle line 16 with conveying means 17 connects steps 6 and 2. A gas line 13 with means for stripping volatile acids (not shown) in step 6 and conveying means 14 with means for dissolving the volatile acids (not shown) in step 2 are also provided. The method of FIG. 3 is operated as follows. The wastewater influent via line 1 and the recycle activated sludge via line 10 enter the organics oxidation step 2 wherein ferric ions (electron donor) are converted to ferrous ions and organics (electron acceptor) are oxidized with the help of microorganisms. Volatile acids are fed in the step 2 from the subsequent steps. Mixture of the wastewater and the recycled sludge forms mixed liquor. The mixed liquor from step 2 is directed via line 3 to the step 4 for rapid oxidation of ferrous ions into ferric, preferably, with air, or oxygen enriched air, or oxygen. Other suitable oxidizers in gaseous, liquid, or solid forms can also be used. Alternatively, electrochemical oxidation can also be used. The oxidation process can be catalyzed. One example of a simple catalyst can be manganese. Rapid oxidation takes from few minutes to an hour. Oxygen uptake in this step is very effective due to iron oxidation, which is a chemosorption process. A substantial portion of the dissolved carbon dioxide is stripped during the rapid oxidation. The mixed liquor enriched with ferric ions is transferred in step 6 wherein ferric ions are reduced to ferrous ions and the bulk of organics is oxidized. This treatment occurs with the participation of microorganisms. Aeration is not needed in this step. Accordingly, the gas produced contains almost only carbon dioxide. One may note that carbon dioxide in a considerably pure form may be extracted from this process. This gas is stripped from the mixed liquor and transferred to step 2. Stripping may be performed, for example, by spraying the mixed liquor in the headspace of the reactor accommodating step 2 and applying vacuum to the headspace by the conveying means 14. The acidic gas will be delivered to step 2 via line 13 and may be dissolved by using, for example, a sparging devise in the reactor accommodating the step 2. Skilled in arts know many other methods of stripping, conveying and dissolving carbon dioxide. These methods can be applied for particular cases as needed. From step 6 the mixed liquor is fed via line 7 in the sludge separator 8 from where the treated water is discharged via line 9 and the separated sludge is recycled back to step 2. Optionally, mixed liquor is recycled from stage 6 to stage 2. In such a case, a residual portion of ferric ions in the step 6 must be sufficient to maintain the process in step 2. Alternatively, the separated sludge may be aerated in the rapid aeration step 15 for the sludge, thus producing ferric ions needed in step 2. Optionally, the sludge is recycled between steps 15 and 19, thus hydrolyzing and oxidizing at least a portion of the sludge and reducing or eliminating the waste sludge.

Embodiments of FIGS. 1 to 3 illustrate that volatile acidic gases can be generated in particular process steps and transferred to another step or recycled back to the step where these gases have been generated. In doing so, the pH and alkalinity in some steps can be increased or decreased as suits a particular application. The main objective of such transfers, including recycles, is to provide more favorable conditions for reactions and matter transformation in oxidation-reduction processes, in processes dependent on acid-base equilibria, and processes dependent on pH and alkalinity and/or acidity in the reacting media. Application domains other than those described herein may also be used.

It will therefore be understood by those skilled in the art that the particular embodiments of the invention here presented are by way of illustration only, and are ment to be in no way restrictive; therefore, numerous changes and modifications may be made, and the full use of equivalents resorted to, without departing from the spirit or scope of the invention as outlined in the upended claims. For example, number of steps as compared to those shown in FIGS. 1 to 3 can be either increased or decreased, but with the condition that volatile acids are transferred from one step to another or recycled within a given step in order to improve the process efficiency and effectiveness. For example, in an anaerobic process volatile acidic gases may be generated in a certain process step and recycled back in the same step. Recycle may involve appropriate dissolution techniques, for example, recycled acidic gases may by dissolved under pressure. Technical applications other than those described in the embodiments of FIGS. 1 to 3 may also be used. For example, the volatile gases loaded with hydrogen sulfide may be treated to utilize sulfur either as hydrogen sulfide, or as sulfur, or in another form. The method can be adapted for treatment of solid and gaseous wastes. The method can also be applied and adapted as needed for treatment of toxic and hazardous waste, including those in the polluted environments. The method can be easily applied to treatment and almost complete decomposition of sludges in anaerobic-aerobic systems. Other applications will become apparent to those skilled in the art in each particular situation when transfer of volatile acids can be beneficial for the process. It is also understood that this method can be applied to non-biological systems.

I claim:

1. A method of a wastewater treatment in a system consisting of at least one acid consuming step and at least one volatile acid generating step and further comprising step of evacuating said volatile acid from said at least one step generating said at least one volatile acid and step of transferring said at least one volatile acid to said at least one acid consuming step.

2. The method of claim 1, wherein said step of evacuating is selected from a group consisting of stripping with an oxidizing gas, stripping with an inert gas, stripping with water vapors, stripping with a reducing gas, vacuum-stripping, heat stripping, and combinations thereof.

3. The method of claim 1, wherein said step of transferring volatile acid is selected from a group consisting of transfer via gas bubbling, transfer with thin film devices, transfer with the use of gas-liquid jets, transfer with mechanical dispersion devices, transfer across a membrane, and combinations thereof.

4. The method of claim 1 and further providing a step of charging recuperable oxidation-reduction species in said system.

5. The method of claim 4, wherein said recuperable oxidation-reduction species are selected from the group consisting of metallic ions, metal containing species, oxyions, nonbiodegradable and insoluble inorganic constituents with variable oxidation-reduction states, nonbiodegradable and insoluble organic constituents with variable oxidation-reduction states, redox ion exchange materials, and combinations thereof.

6. The method of claim 5, wherein said metallic ions and said metal containing species include metals selected from the group consisting of iron, nickel, cobalt, manganese, vanadium, and combinations thereof.

7. The method of claim 1 and further providing a step of charging at least one recuperable pH-buffering species in said system.

8. The method of claim 7, wherein said recuperable pH-buffering species are selected from the group consisting of calcium, iron, nickel, cobalt, and combinations thereof.

9. The method of claim 1, wherein said at least one acid consuming step and at least one step generating volatile acid are selected from the group consisting of one and the same process step, sequential process steps, parallel process steps, process steps with liquid recycle, and combinations thereof.

10. The method of claim 1, wherein at least one of said steps conducted preferably at acidic conditions is provided on a recycle line.

11. The method of claim 1, wherein at least one of said steps generating volatile acid is provided on a recycle line.

12. The method of claim 1, wherein at least one of said acid consuming steps is conducted in a multistage reactor.

13. The method of claim 1, wherein at least one of said acid generating steps is conducted in a multistage reactor.

14. The method of claim 1, wherein said volatile acid is selected from the group comprising carbon dioxide, hydrogen sulfide, volatile fatty acids, and combinations thereof.

15. The method of claim 1, wherein said at least one acid consuming step is conducted in a mode of operation selected from the group comprising a continuous operation, a batch operation, or a combination thereof.

16. The method of claim 1, wherein said at least one acid generating steps is conducted in a mode of operation selected from the group comprising a continuous operation, a batch operation, or a combination thereof.

17. The method of claim 1, wherein said at least one acid consuming and at least one acid generating steps with said transfer of said volatile acids are used for removal of constituents selected from the group consisting of organics removal, BOD removal, COD removal, TOC removal, nutrients removal, phosphorus removal, nitrogen removal, removal of toxic constituents, removal of heavy metals, removal of toxic organics, removal of recalcitrant organics, removal of halogenated organics, removal of sulfur species, and combinations thereof.

18. A method of solid waste treatment in a system consisting of at least one acid consuming step and at least one acid generating step and further providing a step of evacuating said volatile acid from said at least one step of generating said at least one volatile acid and step of transferring said at least one volatile acid to said at least one acid consuming step.

19. The method of claim 18, wherein said solid waste is selected from the group consisting of municipal solid waste, garbage, industrial solid waste, agricultural solid waste, manure, solid waste from animal farms, polluted soils, wastewater sludges, and combinations thereof.

20. A method of treatment of gaseous materials in a system consisting of at least one acid consuming step and at least one acid generating step and further providing a step of evacuating said volatile acid from said at least one step of generating said at least one volatile acid and step of transferring said at least one volatile acid to said at least one acid consuming step.
